(19) United States
(12) Patent Application Publication
(10) Pub. No.: US 2012/0152993 A1
(43) Pub. Date: Jun. 21, 2012

(54) LIGHTWEIGHT BICYCLE BASKET

(75) Inventor: Ming-Yung Chen, FUSHING SHIANG (TW)

(73) Assignee: BRANC CO., LTD., FUSHING SHIANG (TW)

(21) Appl. No.: 12/972,478

(22) Filed: Dec. 19, 2010

(51) Int. Cl. B62J 9/00

(52) U.S. Cl. 224/419

(57) ABSTRACT

A lightweight bicycle basket is made from supporting pipes and a frame. Each of the supporting pipes is made of a material that is lightweight and sufficiently strong for its intended purpose and is formed into a Ushaped hollow pipe. The supporting pipes are arranged at intervals to form a longitudinal layer and a transverse layer. The longitudinal layer is superposed on the transverse layer to form a mesh structure. In this way, the basket has a supporting surface on its bottom, retaining surfaces on its sides, and an accommodating space in its interior. The tips of the supporting pipes are connected by the frame to form a firm structure. The frame is also made of a material with a light weight and sufficient strength and is formed into a loop of hollow pipe.

### BACKGROUND OF THE INVENTION

1. Field of the Invention

The present invention relates to a lightweight bicycle basket, in which the basket is made of a material with a light weight and sufficient strength and made from Ushaped hollow pipes superposed to form a mesh structure, thereby reducing the weight of the basket and maintaining a sufficient structural strength.

2. Description of the Prior Art

In order to transport articles using a bicycle, a basket is often mounted onto the bicycle. As shown in FIGS. 7 and 8, the conventional bicycle basket 20 is made from solid metallic wires, an upper frame 21 and a lower frame 22. The solid metallic wires are arranged at intervals and welded to the upper frame 21 and the lower frame 22, thereby forming the basket 20. The basket 20 has a supporting surface 23 on its bottom, retaining surfaces 24 on its sides and an accommodating space in its interior.

In practice, the abovementioned conventional bicycle basket 20 has the following problems:

(1) The conventional bicycle basket 20 is made from solid metallic wires, which raises the material costs and total weight of the basket. Thus, the conventional bicycle basket 20 does not satisfy lightweight requirements.

(2) The supporting surface 23 formed on the bottom of the basket 20 has a lower strength than the upper frame 21 and the lower frame 22. The supporting surface 23 may easily suffer damage or deformation when a heavyweight article is received in the basket 20. Thus, the conventional bicycle basket 20 has poor strength.

(3) Since the solid metallic wires are welded to the upper frame 21 and the lower frame 22, there are welds on the supporting surface 23, and the welds may have burrs, welding slag or welding craters. As a result, the article received in the basket 20 may be scraped by the burrs, the welding slag or the welding craters of the welds.

In view of the above, the present inventor proposes a novel structure based his expert experience and considered research in this field.

### SUMMARY OF THE INVENTION

In order to solve the above problems, an objective of the present invention is to provide a lightweight bicycle basket having a plurality of supporting pipes and a frame. Each of the supporting pipes is made of a lightweight material having sufficient strength and is formed into a Ushaped hollow pipe. The supporting pipes are arranged at intervals to form a longitudinal layer and a transverse layer. The longitudinal layer is superposed on the transverse layer to form a mesh structure. In this way, the basket has a supporting surface on its bottom, retaining surfaces on its sides, and an accommodating space in its interior. The tips of the supporting pipes are connected by the frame to form a firm structure. The frame is also made of a material with a light weight and sufficient strength and is formed into a loop of hollow pipe. With this structure, a lightweight bicycle basket of the present invention is obtained.

The present invention provides a lightweight bicycle basket. When an article is disposed in the accommodating space, since there are no welds on the supporting surface and the retaining surfaces, the article avoids being scrapped by welding burrs. Further, the Ushaped supporting pipes are arranged at intervals to form a longitudinal layer and a transverse layer, and the longitudinal layer is disposed on the transverse layer to form a mesh structure. As a result, a stress applied on the supporting surface which is formed on the bottom of the basket can be distributed uniformly. Thus, the bottom of the basket avoids damage or deformation due to heavyweight articles. Therefore, the basket of the present invention has an improved structural strength and a reduced weight.

### BRIEF DESCRIPTION OF THE DRAWINGS

FIG. 1 is a perspective view of an embodiment of the present invention;

FIG. 2 is an exploded perspective view of an embodiment of the present invention;

FIG. 3 is a crosssectional view of an embodiment of the present invention;

FIG. 4 is a bottom view showing a meshed bottom of a bicycle basket of an embodiment of the present invention;

FIG. 5 is a top view showing a meshed bottom of a bicycle basket of an embodiment of the present invention;

FIG. 6 is a bottom view showing another preferred embodiment of the present invention;

FIG. 7 is a perspective view of a conventional bicycle basket; and

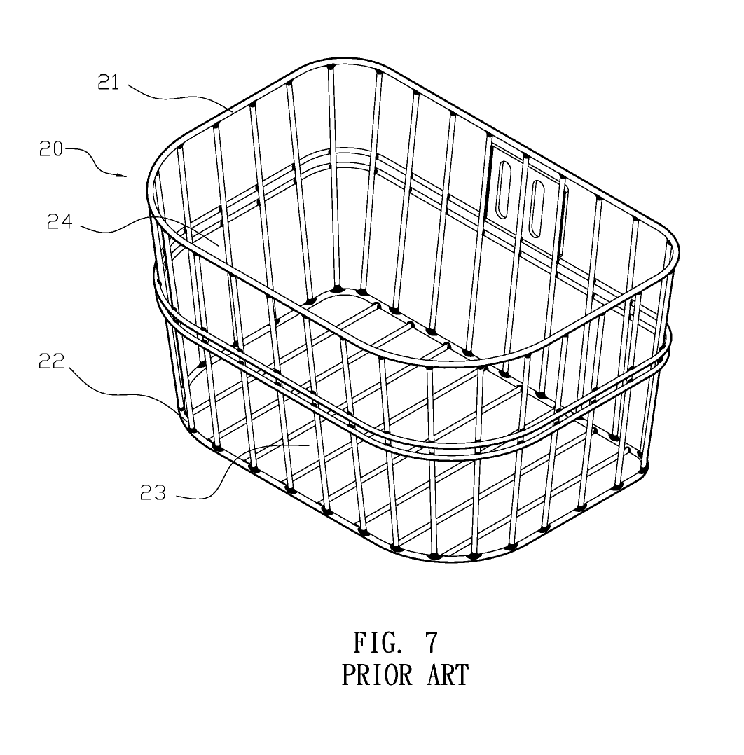

FIG. 8 is a detailed view of welds formed on a conventional bicycle basket.

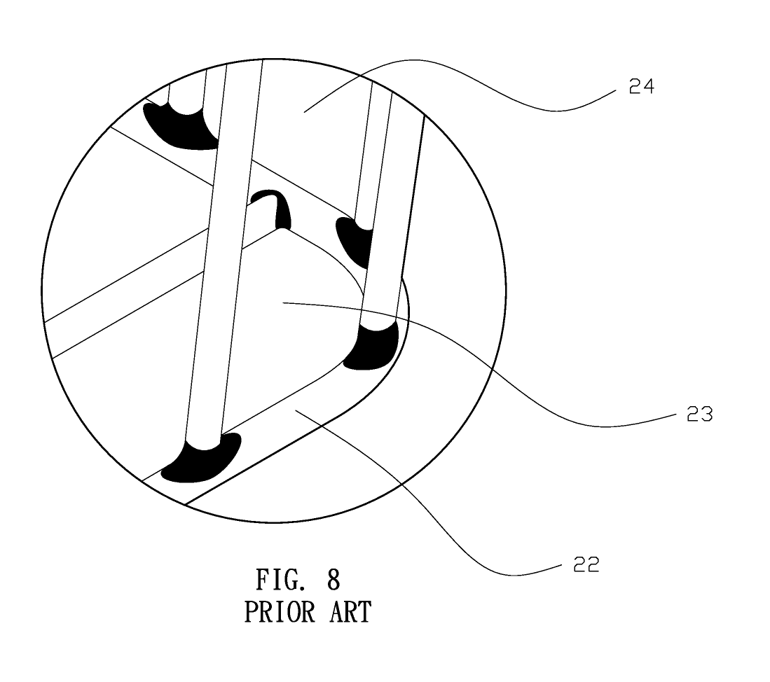

### DETAILED DESCRIPTION OF THE INVENTION

In order to better understand the objectives, features and effects of the present invention, a detailed description will be made hereinafter with reference to the accompanying drawings.

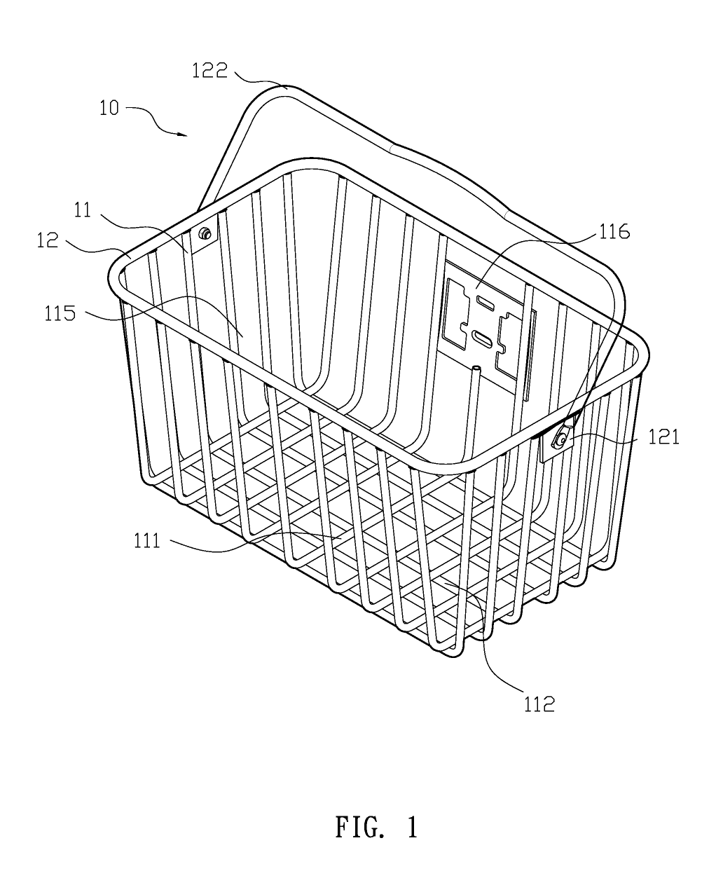

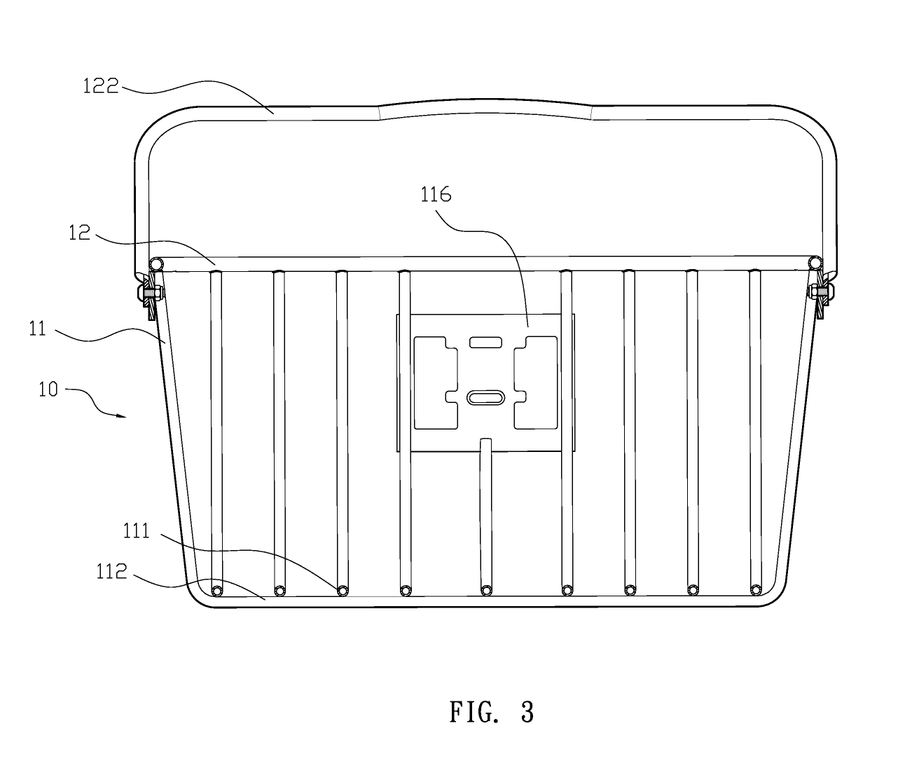

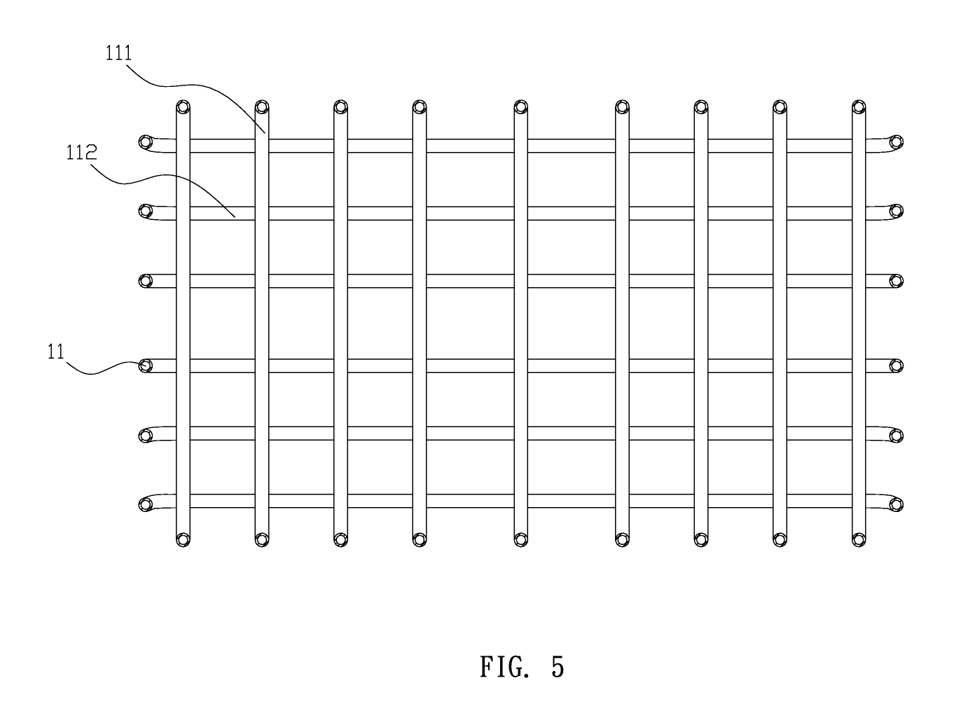

Please refer to FIGS. 1 to 5. An embodiment of the present invention provides a lightweight bicycle basket 10. The basket 10 is made from a plurality of supporting pipes 11 and a frame 12. Each of the supporting pipes 11 is made of a material that is light weight and of sufficient strength, such as aluminum, and is formed into a Ushaped hollow pipe. The supporting pipes 11 are arranged at intervals to form a longitudinal layer 111 and a transverse layer 112. The longitudinal layer 111 is superposed on the transverse layer 112 to form a mesh structure. With this structure, the basket 10 has a supporting surface 113 on its bottom, retaining surfaces 114 on its sides, and an accommodating space 115 in its interior. A connecting element 116 is provided on one of the retaining surfaces 114, so that the basket 10 can be connected to the bicycle at the connecting element 116 by way of welds. The frame 12 is also made of a lightweight material of sufficient strength, such as aluminum, and is formed into a loop of hollow pipe. Both sides of the frame 12 are provided with a combining piece 121. A carrying handle 122 is pivotally provided between the two combing pieces 121 by means of nuts and bolts.

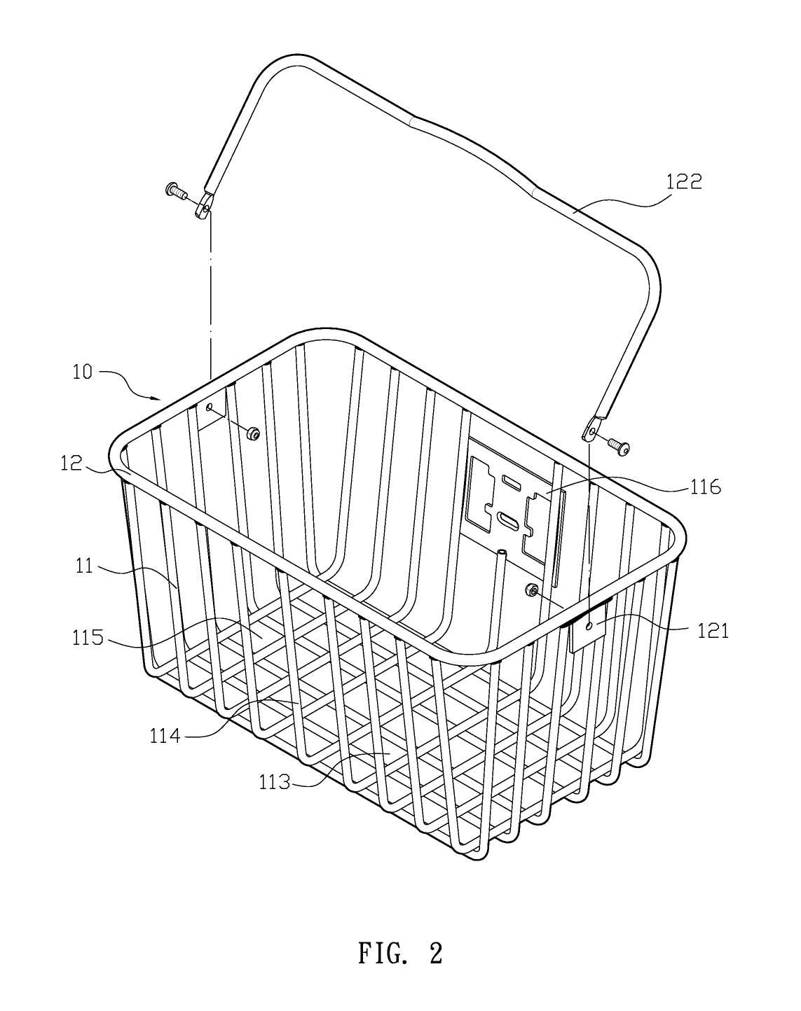

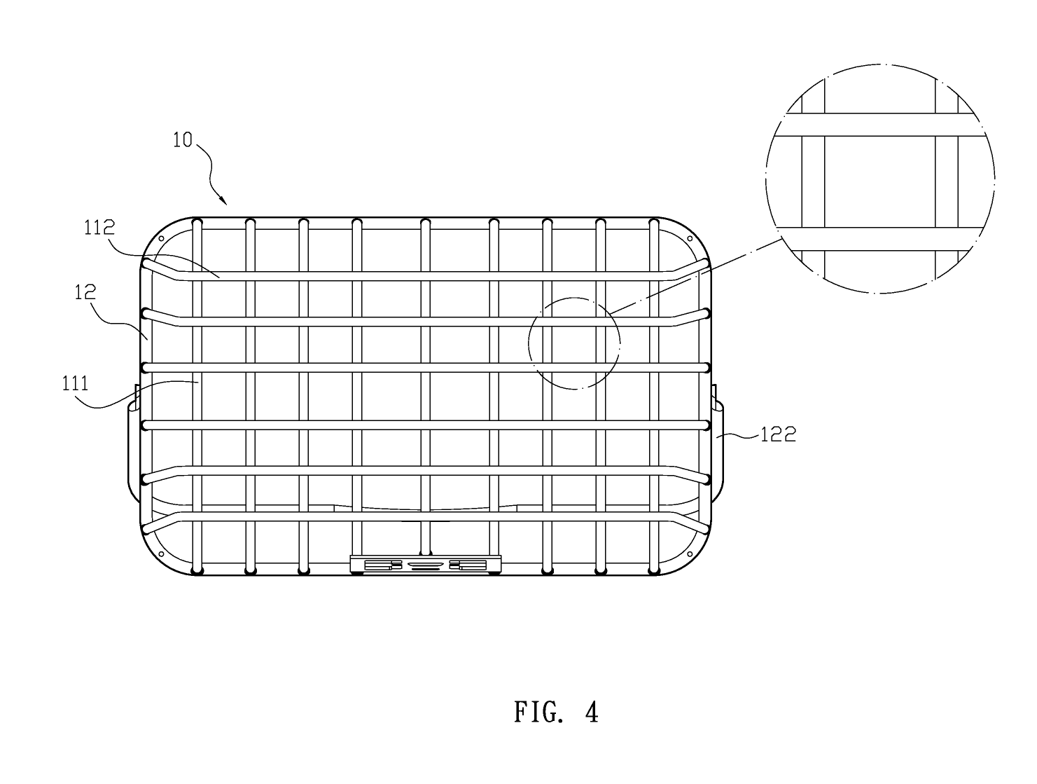

Please refer again to FIGS. 2 and 4. With the abovementioned structure, in use, the basket 10 is fixed to the front of a handlebar of the bicycle, and an article can be disposed into the accommodating space 115 from the upper side of the basket 10. Since there are no welds on the supporting surface 113 and the retaining surfaces 114, the article received in the basket 10 avoids being scrapped by burrs from the welds. Further, the Ushaped supporting pipes 11 are arranged at intervals to form the longitudinal layer 111 and the transverse layer 112, and the longitudinal layer 111 is disposed on the transverse layer 112 to form a mesh structure. As a result, any stress applied onto the supporting surface 113 which is formed on the bottom of the basket 10 can be distributed uniformly. Thus, the bottom of the basket 10 avoids damage or deformation due to a heavyweight articles. Therefore, the basket 10 has increased structural strength and a reduced weight. On the other hand, when the basket 10 is detached from the bicycle, a user can hold the carrying handle 122 together with the article received in the basket 10, thereby improving the practicability and convenience of such embodiments of the present invention.

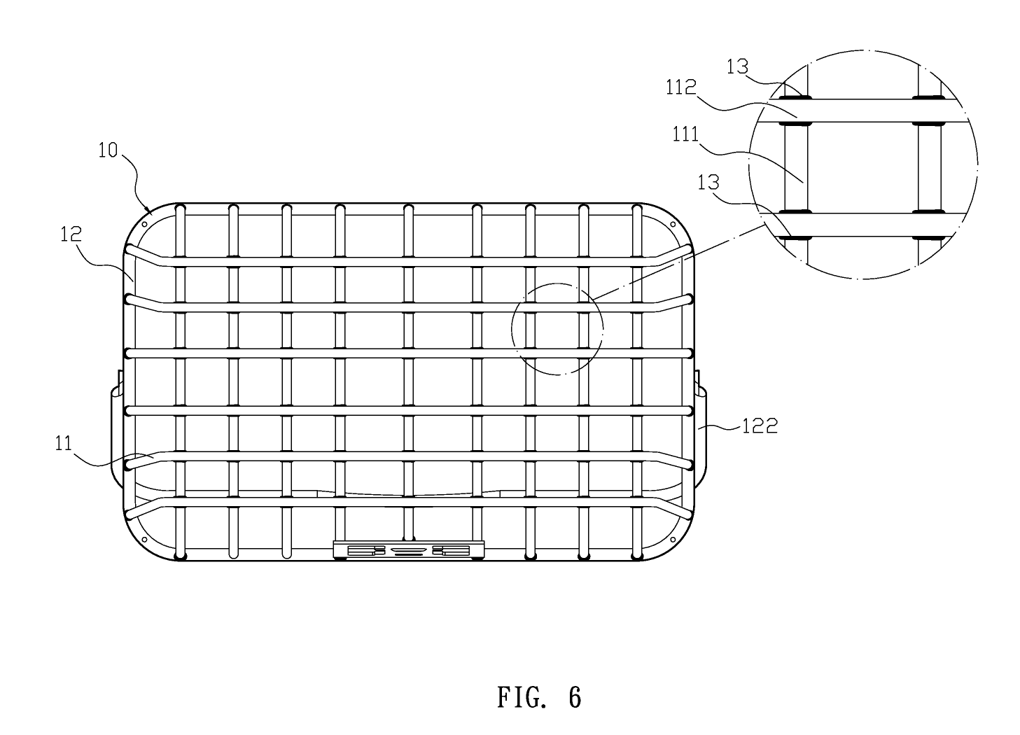

FIG. 6 shows another embodiment of the present invention, in which the connecting points of the longitudinal layer 111 and the transverse layer 112 are firmly joined with welds 13 formed therebetween, thereby increasing the structural strength of the basket 10. Further, since the welds 13 are hidden between the longitudinal layer 111 and the transverse layer 112, the article received in the basket 10 does not suffer from scrapes by weld burrs.

According to the above embodiments, embodiments of the present invention have the following advantageous features. When an article is disposed into the accommodating space 115, since there are no welds on the supporting surface 113 and the retaining surfaces 114, the article avoids being scrapped by burrs. Further, the Ushaped supporting pipes 11 are arranged at intervals to form the longitudinal layer 111 and the transverse layer 112, and the longitudinal layer 111 is disposed on the transverse layer 112 to form a mesh structure. As a result, a stress applied on the supporting surface 113 which is formed on the bottom of the basket 10 can be distributed uniformly. Thus, the bottom of the basket 10 can be prevented from suffering damage or deformation due to heavyweight articles. Therefore, the basket 10 has an improved structural strength and a reduced weight.

According to the above, the present invention demonstrates industrial applicability, novelty and inventive steps, and thus conforms to the requirements for an invention patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A lightweight bicycle basket, including a plurality of supporting pipes and a frame,
wherein each of the supporting pipes is from a material that is lightweight and of sufficient strength and is formed into a Ushaped hollow pipe, the supporting pipes arranged at intervals to form a longitudinal layer and a transverse layer, the longitudinal layer superposed on the transverse layer to form a mesh structure, so that the basket has a supporting surface a bottom portion, retaining surfaces on sides and an accommodating space in an interior, tips of the supporting pipes connected by the frame to form a firm structure, wherein the frame is made of a material with a light weight and sufficient strength and is formed into a loop hollow pipe; and
whereby, when an article is disposed into the accommodating space of the basket, since there are no welds on the supporting surface and the retaining surfaces, the article avoids being scraped by burrs of the welds, and the Ushaped supporting pipes are arranged at intervals to form the longitudinal layer and the transverse layer, and the longitudinal layer is disposed on the transverse layer to form the mesh structure, so that a stress applied on the supporting surface of the basket is distributed uniformly, thereby preventing the bottom of the basket from suffering damage or deformation due to a heavyweight article and providing a basket with an improved structural strength and a reduced weight.

2. The lightweight bicycle basket according to claim 1, wherein each of the supporting pipes and the frame is made of aluminum.

3. The lightweight bicycle basket according to claim 1, wherein a connecting element is provided on one of the retaining surfaces to connect the basket to a bicycle.

4. The lightweight bicycle basket according to claim 1, wherein the supporting pipes are connected to the frame by welds.

5. The lightweight bicycle basket according to claim 1, wherein both sides of the frame are provided with a combining piece, and a carrying handle is pivotally provided between the two combining pieces by nuts and bolts.

6. The lightweight bicycle basket according to claim 1, wherein connecting points of the longitudinal layer and the transverse layer are joined by welds, and the welds are hidden between the longitudinal layer and the transverse layer.
